(19) United States
(12) Patent Application Publication
(10) Pub. No.: US 2004/0008517 A1
(43) Pub. Date: Jan. 15, 2004

(54) Magnetically operated reed switch

(76) Inventors: Randall L. Bixler, LaGrange, IN (US); Frank Roe, Wolcottville, IN (US)

Correspondence Address: Todd T. Taylor, TAYLOR & AUST, P.C., 142 S. Main St., P.O. Box 560, Avilla, IN, 46710, US

(21) Appl. No.: 10/194,903

(22) Filed: Jul. 12, 2002

(51) Int. Cl. F21V 23/04; B60Q 3/06

(52) U.S. Cl. 362/394; 362/276; 362/496

(57) ABSTRACT

A light assembly including a housing, a light, a magnet and a magnetic field sensing switch positioned within the housing. The magnetic field sensing switch having at least two electrical conductors including at least one electrical conductor connected to the light. The magnet being moveably disposed in the housing.

### BACKGROUND OF THE INVENTION

1. Field of the Invention

The present invention relates to an electric switch, and, more particularly, to a magnetically operated reed switch.

2. Description of the Related Art

A mercury switch is activated/deactivated by the orientation thereof within a gravitational field. Mercury switches include two or more electrodes, which are separated within an enclosed ampoule. The electrodes extend through the ampoule and are electrically connected to other circuitry. Within the ampoule there is an amount of mercury occupying a position therein dependant upon the direction of the gravitational field and/or acceleration. When the ampoule is oriented such that the mercury contacts at least two electrodes, those electrodes are then electrically connected due to the electrical conductivity of the mercury. The connecting of the electrodes is used to switch a circuit on and/or as an input to a device for which orientation detection is desired. The Environmental Protection Agency is actively involved in industrial/government programs for removing mercury switches from vehicles and for ensuring that mercury, contained in thermostats, is collected rather than being buried in landfills that would lead to the pollution of ground water.

A reed switch is a device that often is used as a proximity sensor for the detecting of the presence of a magnetic field. The reed switch is actually a mechanically contacting switch having two ferromagnetic contacts. The ferromagnetic contacts can be either normally open or normally closed. The presence of a magnetic field is introduced by bringing a magnet into proximity with the reed switch. The magnetic field either attracts the two contacts, which are in a normally open position, or repels the two contacts of a normally closed reed switch.

Reed switches are employed in motion detection devices such as burglar alarms where a magnet is located on a door and a reed switch is attached to the door frame. When the door is opened, the reed switch opens, due to the magnetic field being removed, thereby sending a signal to the burglar alarm.

What is needed in the art is a device that does not contain a toxic pollutant and can detect the orientation of the device and electrically switch a device on or off.

### SUMMARY OF THE INVENTION

The present invention provides a magnetically operated reed switch assembly which is activated by the orientation of the assembly.

The invention comprises, in one form thereof, a light assembly including a housing, a light, a magnet and a magnetic field sensing switch positioned within the housing. The magnetic field sensing switch having at least two electrical conductors including at least one electrical conductor connected to the light. The magnet being moveably disposed in the housing.

An advantage of the present invention is that the magnetically operated reed switch assembly senses an orientation and switches a light or other circuit on or off.

Another advantage is that the present invention does not use mercury.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematicized cross-sectional view of a modular furniture shelving unit illustrating an embodiment of a magnetically operated reed switch of the present invention;

FIG. 2 is a perspective cross-sectional view of the magnetically operated reed switch of FIG. 1;

FIG. 3 is a schematicized cross-sectional view of the magnetically operated reed switch of FIGS. 1 and 2;

FIG. 4 is another schematicized cross-sectional view of the magnetically operated reed switch of FIGS. 1-3;

FIG. 5 is a schematicized cross sectional view of a vehicle including an embodiment of a magnetically operated reed switch of the present invention;

FIG. 6 is another schematicized cross-sectional view of the magnetically operated reed switch of FIG. 5;

FIG. 7 is a schematicized cross-sectional view of the magnetically operated reed switch, oriented as shown in FIG. 5;

FIG. 8 is a schematicized cross-sectional view of the magnetically operated reed switch, oriented as shown in FIG. 6; and

FIG. 9 is a schematicized cross-sectional view of another embodiment of a magnetically operated reed switch with a remote light of the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

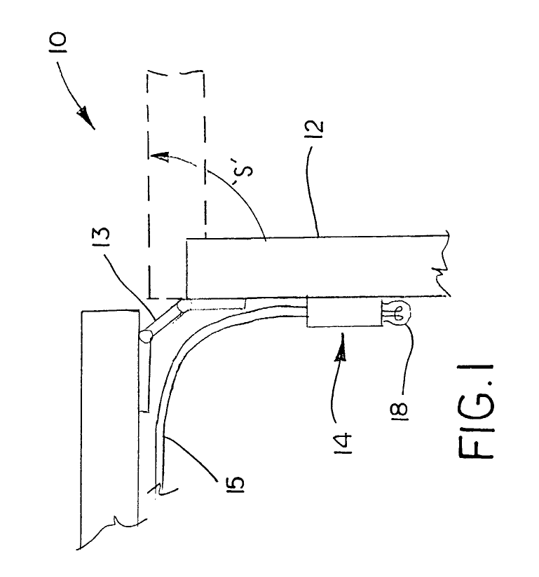

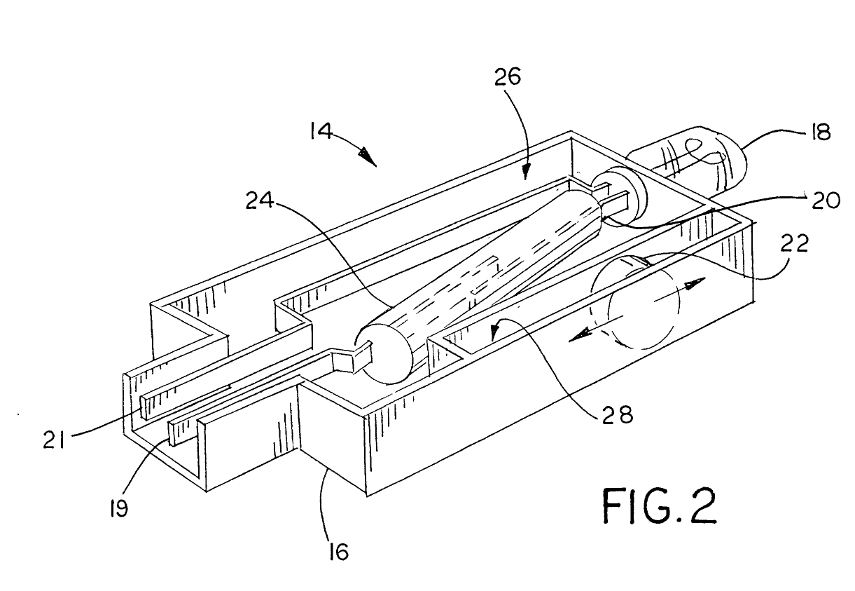

Referring now to the drawings, and more particularly to FIGS. 1-4, there is shown a modular furniture shelving unit 10, including lid 12 and magnetically operated reed switch 14.

Modular furniture shelving unit 10 is attached to a modular furniture wall panel in an office environment. Lid 12 is hingedly attached to shelving unit 10 and is opened in direction S, pivoting about hinge 13.

Magnetically operated reed switch 14 includes housing 16, light 18, conductors 19, 20 and 21, magnet 22 and reed switch 24. Magnetically operated reed switch 14 is attached to lid 12 and as lid 12, moving in direction S, reaches a predetermined orientation, magnetically operated reed switch 14 is activated causing light 18 to illuminate.

Magnetically operated reed switch 14 includes housing 16 with light 18 mounted thereon. Light 18 is a light-emitting device, which is illustrated as an incandescent light bulb. Light 18 is replaceable as in a conventional screw-in or automotive-type light bulb or light 18 may be permanently connected to housing 16. Conductors 19, 20 and 21 provide electrical interconnection within magnetically operated reed switch 14. Conductor 19 electrically connects an electrical power source (not shown), by way of conventional wiring, to a terminal of reed switch 24. Conductor 20 electrically connects another terminal of reed switch 24 to one end of a filament in light 18. Conductor 21 connects the other end of the filament in light 18 to an electrical neutral or return line.

Housing 16 includes a first cavity 26 and a second cavity 28. First cavity 26 contains reed switch 24 and the electrical connections to light 18 and the electrical connection to an external electrical power source. First cavity 26 provides for the positioning of reed switch 24 proximate to one end of second cavity 28. First cavity 26 may be filled with a potting material or even be injection molded as a solid piece containing reed switch 24 and the associated electrical connections. Second cavity 28 is shaped to accommodate magnet 22 and to allow magnet 22 to move therein. One part of cavity 28 is disposed proximate reed switch 24 so that when magnet 22 is in that part of cavity 28 the contacts within reed switch 24 are attracted to each other thereby closing an electrical circuit.

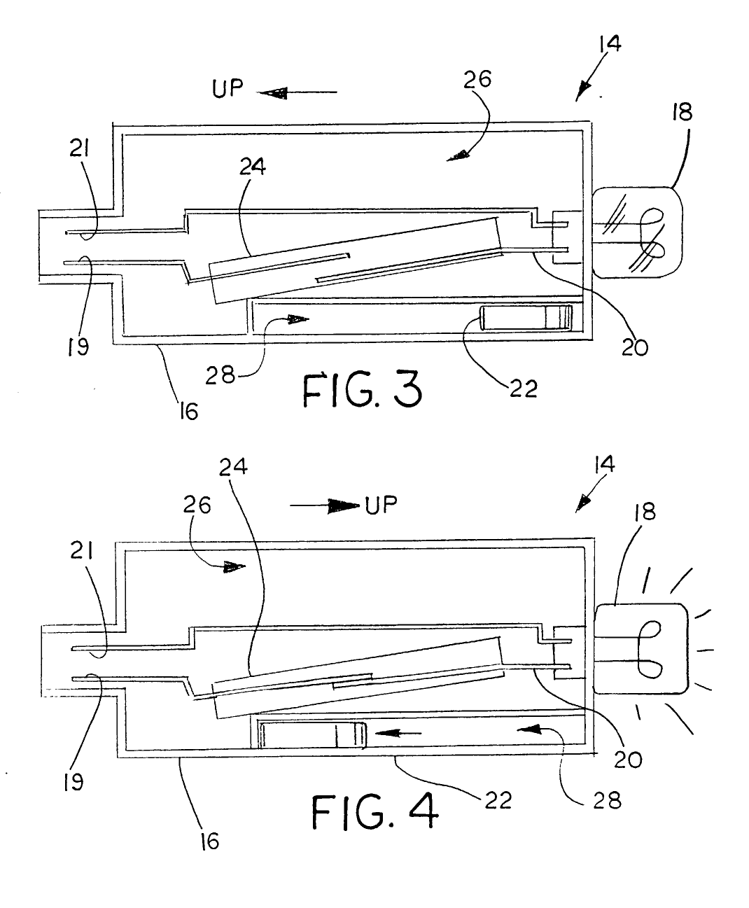

Magnet 22 is a permanent magnet, which has a magnetic field sufficient to cause the contacts of reed switch 24 to come into contact with each other when magnet 22 is in one position within second cavity 28 (as shown in FIG. 4). When magnet 22 is in an other position within second cavity 28 (as shown in FIG. 3) the magnetic field from magnet 22, in the area of reed switch 24, is diminished causing the contacts of reed switch 24 to disengage. Magnet 22 may alternatively be partially constrained within second cavity 28. Alternatively, second cavity 28 may be omitted with magnet 22 constrained to follow a particular path within first cavity 26, such constraint may be provided by a projection from housing 16.

Reed switch 24 is disposed within first cavity 26 of housing 12 and is oriented toward one end of second cavity 28. Reed switch 24 is a magnetic field sensing device having contacts therein that make electrical contact in the presence of a magnetic field. Magnet 22 is at least partially enclosed within second cavity 28 and is allowed to slide or roll therein. When magnet 22 is positioned proximate reed switch 24 (as shown in FIG. 4) electrical connection is made within reed switch 24 allowing current to pass therethrough. When magnetically operated reed switch 14 is reoriented such that magnet 22 is disposed away from reed switch 24 (as in FIG. 3) then the electrical current, through reed switch 24, is stopped by the opening of the contacts therein.

Now, additionally referring to FIGS. 7 and 8, second cavity 28 may be in the form of profiled channel 28, which is shaped to accommodate a particular shape of magnet 22. Magnet 22 consists of a disc-like magnet, which can slide or roll within profiled channel 28 and be proximate to reed switch 24 in one particular orientation of housing 16. Profiled channel 28 may be angularly biased to ensure that light 18 is off in one particular orientation of housing 16 and that light 18 is on when housing 16 is oriented in another orientation. For example, in FIGS. 3 and 4 two orientations of magnetically oriented reed switch 14 are shown. FIG. 3 illustrates the position of magnet 22, when magnet 22, being drawn by gravity, is disposed away from reed switch 24 thereby allowing normally open contacts in reed switch 24 to be open. FIG. 4 illustrates magnet 22 having been drawn by gravity to a position opposite that shown in FIG. 3. When magnet 22 is so disposed, proximate reed switch 24, the contacts therein close allowing electric current to flow through reed switch 24 and the rest of the circuit, thereby illuminating light 18. Profiled channel 28 may be shaped in a non-linear manner, thereby enhancing the hysteresis of the system.

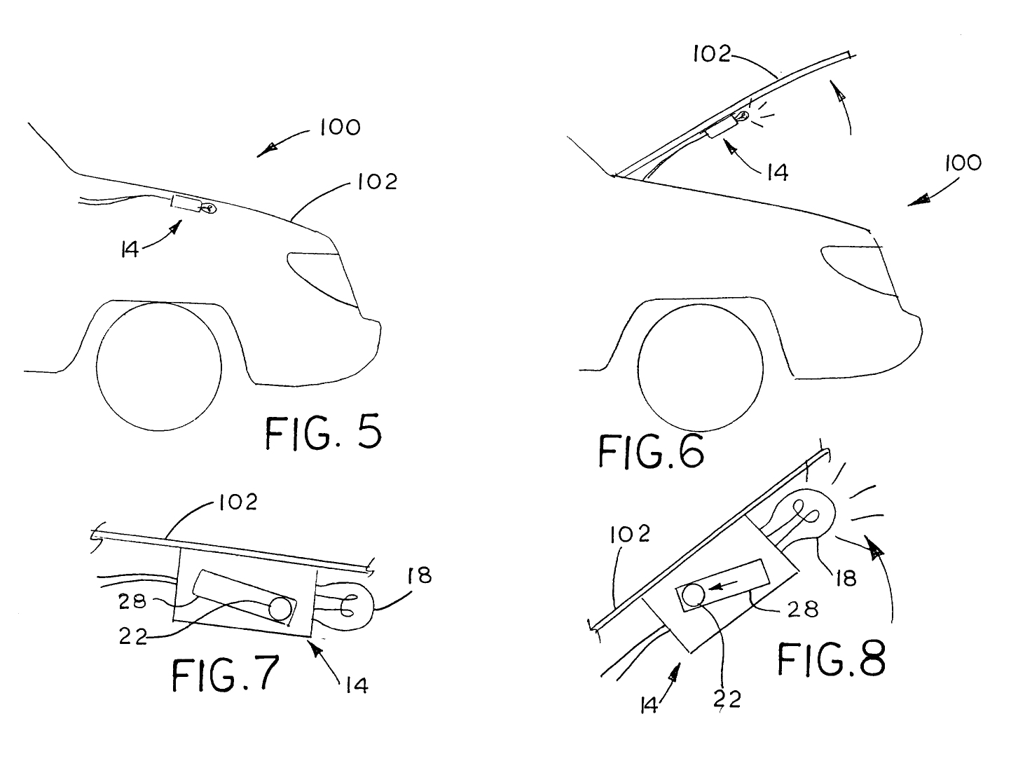

Now, additionally referring to FIGS. 5-8, there is illustrated another embodiment of the present invention including vehicle 100 having vehicle hood 102 and magnetically operated reed switch 14. Magnetically operated reed switch 14 functions as described above. When vehicle hood 102 is oriented as shown in FIG. 5, the angular bias of profiled channel 28 disposes magnet 22 away from reed switch 24. When vehicle hood 102 is lifted, as shown in FIG. 6, magnet 22 rolls to an area proximate reed switch 24 at another end of profiled channel 28.

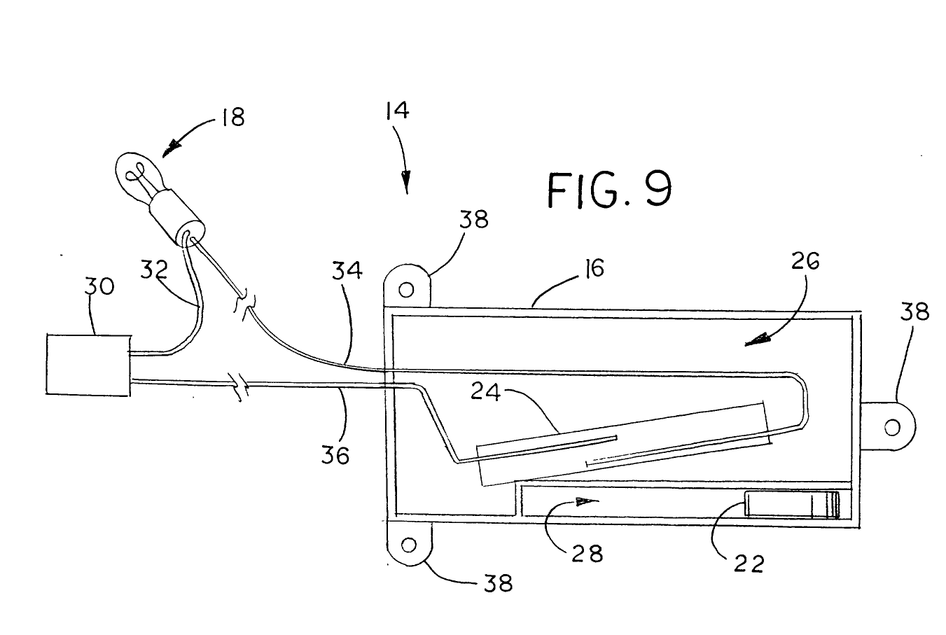

Now, additionally referring to FIG. 9, another embodiment of the present invention is shown including connector 30, conductors 32, 34 and 36 and mounting tabs 38. FIG. 9 illustrates that light 18 can be physically remote from magnetically operated reed switch 14. This arrangement allows light 18 to be positioned in a desired location so that movement of switch 14 doesn't alter the light pattern from light 18. This also advantageously places light 18 away from a moving structure.

Connector 30 is electrically connected to one end of conductors 32 and 36. Connector 30 is an electrical interface to a power source (not shown). An other end of conductor 32 and one end of conductor 34 are electrically connected to light 18. An other end of conductors 32 and 36 are electrically connected to reed switch 24. Mounting tabs 38 are attached to housing 16 allowing the mounting of switch 14 to an angularly displaceable device. Mounting tabs 38 have holes therethrough for the passage of mechanical fasteners.

Although magnet 22 has been illustrated as a gravitationally biased single magnet constrained within second cavity 28, more than one magnet in more than one cavity may be utilized, to effect operation of reed switch 24, in various orientations of magnetically operated reed switch 14. Alternatively, magnet 22 may be biased with a spring or other device to provide a similar effect as an angular bias in a gravitational field.

To utilize magnetically operated reed switch 14 in a system, an installer attaches magnetically operated reed switch 14 to a device, which is angularly displaceable. Once magnetically operated reed switch 14 is installed upon an angularly displaceable device, the reorienting of the angularly displaceable device, and thus the reorientation of magnetically operated reed switch 14, allows magnet 22 to be positioned either proximate to or away from reed switch 24 causing light 18 to, respectively, illuminate or extinguish.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A light assembly, comprising:
a housing;
a light;
a magnetic field sensing switch positioned within said housing, said magnetic field sensing switch having at least two electrical conductors including at least one said electrical conductor connected to said light; and
a magnet disposed within said housing and moveably disposed in said housing.

2. The assembly of claim 1, wherein said magnet has at least two positions including a first position and a second position, said magnetic field sensing switch electrically connecting at least two of said electrical conductors when said magnet is in said first position, and said magnetic field sensing switch electrically disconnecting at least two of said electrical conductors when said magnet is in said second position.

3. The assembly of claim 1, wherein said housing includes a first cavity and a second cavity, said magnetic field sensing switch being at least partially disposed within said first cavity and said magnet being at least partially disposed within said second cavity.

4. The assembly of claim 3, wherein said second cavity further comprises a profiled channel shaped to coact with the shape of said magnet and the orientation of said profiled channel relative to the gravitational field thereby effecting the position of said magnet in said profiled channel.

5. The assembly of claim 4, wherein said magnet has a first position and a second position in said profiled channel, said magnetic field sensing switch being activated when said magnet is in said first position in said profiled channel thereby causing said light to emit light.

6. The assembly of claim 5, wherein said profiled channel is orientated relative to the gravitational field to bias said magnet in a predetermined position.

7. The assembly of claim 3, wherein said magnet is slidably disposed within said second cavity.

8. The assembly of claim 1, wherein said magnetic field sensing switch is a reed switch.

9. The assembly of claim 1, wherein said light is carried by said housing.

10. A switch assembly, comprising:
a housing;
a magnetic field sensing switch positioned within said housing, said magnetic field sensing switch including at least two electrical conductors; and
a magnet moveably disposed in said housing.

11. The assembly of claim 10, wherein said magnet has at least two positions including a first position and a second position, said magnetic field sensing switch electrically connecting at least two of said electrical conductors when said magnet is in said first position, and said magnetic field sensing switch electrically disconnecting at least two of said electrical conductors when said magnet is in said second position.

12. The assembly of claim 10, wherein said housing includes a first cavity and a second cavity, said magnetic field sensing switch being at least partially disposed within said first cavity and said magnet being at least partially disposed within said second cavity.

13. The assembly of claim 12, wherein said second cavity farther comprises a profiled channel shaped to coact with the shape of said magnet and the orientation of said profiled channel relative to the gravitational field thereby effecting the position of said magnet in said profiled channel.

14. The assembly of claim 13, wherein said magnet has a first position and a second position in said profiled channel, said magnetic field sensing switch being activated when said magnet is in said first position in said profiled channel.

15. The assembly of claim 14, wherein said profiled channel is orientated relative to the gravitational field to bias said magnet in a predetermined position.

16. The assembly of claim 10, wherein said magnetic field sensing switch is a reed switch.

17. A switched light assembly, comprising:
an angularly displaceable device;
an orientationally activated lighting device connected to said angularly displaceable device, said lighting device including:
a housing;
a light carried by said housing;
a magnetic field sensing device positioned within said housing, said magnetic field sensing device having at least two electrical conductors including at least one said electrical conductor connected to said light; and
a magnet moveably disposed in said housing.

18. The assembly of claim 17, wherein said magnet has at least two positions including a first position and a second position, said magnetic field sensing device electrically connecting at least two of said electrical conductors when said magnet is in said first position, and said magnetic field sensing device electrically disconnecting at least two of said electrical conductors when said magnet is in said second position.

19. The assembly of claim 17, wherein said housing includes a first cavity and a second cavity, said magnetic field sensing switch being at least partially disposed within said first cavity and said magnet being at least partially disposed within said second cavity.

20. The assembly of claim 19, wherein said second cavity further comprises a profiled channel shaped to coact with the shape of said magnet and the orientation of said profiled channel relative to the gravitational field thereby effecting the position of said magnet in said profiled channel.

21. The assembly of claim 20, wherein said magnet has a first position and a second position in said profiled channel, said magnetic field sensing device being activated when said magnet is in said first position.

22. The assembly of claim 21, wherein said profiled channel is orientated relative to the gravitational field to bias said magnet in a predetermined position.

23. The assembly of claim 17, wherein said angularly displaceable device is a vehicle hood.

24. The assembly of claim 17, wherein said angularly displaceable device is a hinged lid.

25. An office furniture assembly, comprising:
a hinged lid being hinged in a generally horizontal axis;
an orientationally activated light assembly connected to said hinged lid, the light assembly, including:
a housing;
a light carried by said housing;
a magnetic field sensing device positioned within said housing, said magnetic field sensing device having at least two electrical conductors including at least one said electrical conductor connected to said light; and
a magnet moveably disposed in said housing.

26. The assembly of claim 25, wherein said magnet has at least two positions including a first position and a second position, said magnetic field sensing device electrically connecting at least two of said electrical conductors when said magnet is in said first position, and said magnetic field sensing device electrically disconnecting at least two of said electrical conductors when said magnet is in said second position.

27. The assembly of claim 25, wherein said housing includes a first cavity and a second cavity, said magnetic field sensing switch being at least partially disposed within said first cavity and said magnet being at least partially disposed within said second cavity.

28. The assembly of claim 27, wherein said second cavity further comprises a profiled channel shaped to coact with the shape of said magnet and the orientation of said profiled channel relative to the gravitational field thereby effecting the position of said magnet in said profiled channel.

29. The assembly of claim 28, wherein said magnet has a first position and a second position in said profiled channel, said magnetic field sensing device being activated when said magnet is in said first position.

30. The assembly of claim 29, wherein said profiled channel is orientated relative to the gravitational field to bias said magnet in a predetermined position.

31. A method of operating a light switch, comprising the steps of:
installing the light switch on an angularly displaceable device, the light switch including a housing and a light, said housing having a magnetic field sensing device and a magnet at least partially disposed within said housing; and
reorienting said angularly displaceable device.

32. The method of claim 31, wherein said angularly displaceable device is one of a vehicle hood and a horizontally hinged lid.

33. The method of claim 31, wherein said reorienting step further comprises the step of causing said magnet to move from a first position to a second position.

34. The method of claim 33, wherein said light is illuminated when said magnet is in said first position and said light is extinguished when said magnet is in said second position.
